(19) United States
(12) Patent Application Publication
(10) Pub. No.: US 2015/0149740 A1
(43) Pub. Date: May 28, 2015

(54) DATA STORAGE DEVICE AND DATA PROCESSING SYSTEM INCLUDING THE SAME

(71) Applicant: SK hynix Inc., Gyeonggi-do (KR)

(72) Inventors: Dong Jae SHIN, Gyeonggi-do (KR); Soo Nyun KIM, Gyeonggi-do (KR)

(73) Assignee: SK hynix Inc., Gyeonggi-do (KR)

(21) Appl. No.: 14/161,413

(22) Filed: Jan. 22, 2014

(30) Foreign Application Priority Data
Nov. 22, 2013 (KR) 10-2013-0143038

(51) Int. Cl. G06F 12/02; G06F 21/60

(52) U.S. Cl. CPC G06F 12/023; G06F 21/60; G06F 2212/1052
USPC 711/166

(57) ABSTRACT

A data processing system includes a data storage device including memory cells, which are erased to an erasure state and programmed to program states to store data, and a host device suitable for accessing the data, wherein the data storage device programs a first memory cell to a first state other than the erasure state to delete data of the first memory cell in response to a request of the host device.

### CROSS-REFERENCES TO RELATED APPLICATION

The present application claims priority under 35 U.S.C. §119(a) to Korean application number 10-2013-0143038, filed on Nov. 22, 2013, in the Korean Intellectual Property Office, which is incorporated herein by reference in its entirety.

### BACKGROUND

1. Technical Field

Various embodiments relate to a data storage device, and more particularly, to a data storage device capable of preventing exposure of security data and a data processing system including the same.

2. Related Art

The paradigm for the computer environment has shifted into ubiquitous computing environment so that computer systems can be used anytime and anywhere. As a result, the use of portable electronic devices such as mobile phones, digital cameras, and laptop computers has rapidly increased. In general, such portable electronic devices use a data storage device which uses a memory device.

Since a data storage device using a memory device has no mechanical driving part, it has excellent stability and durability, a high information access speed, and relatively low power consumption. Data storage devices having such properties include a universal serial bus (USB) memory device, a universal flash storage (UFS) device, a memory card having various interfaces, and a solid state drive (SSD).

### SUMMARY

A data storage device capable of preventing exposure of security data and a data processing system including the same are described herein.

In an exemplary embodiment of the present disclosure, a data processing system includes a data storage device including memory cells, which are erased to an erasure state and programmed to program states to store data, and a host device suitable for accessing the data, wherein the data storage device programs a first memory cell to a first state other than the erasure state to delete data of the first memory cell in response to a request of the host device.

In another exemplary embodiment of the present disclosure, a data storage device includes a nonvolatile memory device including memory cells, which are erased to an erasure state and programmed to program states to store data, and a controller suitable for deleting data of a first memory cell by changing a threshold voltage of the first memory cell to a first state other than the erasure state.

In another exemplary embodiment of the present disclosure, a data processing system Includes a host device, a data storage device suitable for storing data which are to be accessed by the host device and comprising a nonvolatile memory device which includes memory cells, and a controller suitable for controlling the nonvolatile memory device, wherein, when erasure of data is requested from the host device, the controller controls the nonvolatile memory device such that a target memory cell in which erase-requested data is stored is programmed.

According to the embodiments of the present disclosure, it may substantially prevent exposure of the security data stored in a data storage device.

### BRIEF DESCRIPTION OF THE DRAWINGS

Features, aspects, and embodiments are described in conjunction with the attached drawings, in which:

FIG. 1 is a block diagram explaining a data erase operation of a data processing system in accordance with an embodiment of the present disclosure;

FIG. 2 is a block diagram explaining a data update operation of a data processing system in accordance with an embodiment of the present disclosure;

FIGS. 3 to 5 are threshold voltage distribution diagrams of memory cells of nonvolatile memory devices of FIGS. 1 and 2;

FIG. 6 is a block diagram exemplarily showing a data processing system in accordance with an embodiment of the present disclosure;

FIG. 7 is a block diagram exemplarily showing a data processing system, which includes a solid state drive (SSD) in accordance with an embodiment of the present disclosure;

FIG. 8 is a block diagram exemplarily showing a SSD controller shown in FIG. 7; and

FIG. 9 is a block diagram exemplarily showing a computer system in accordance with an embodiment of the present disclosure.

### DETAILED DESCRIPTION

In the present disclosure, advantages, features, and methods for achieving them will become more apparent after a reading of the following exemplary embodiments taken in conjunction with the drawings. The present disclosure may, however, be embodied in different forms and should not be construed as being limited to the embodiments set forth herein. Rather, these embodiments are provided to describe the present disclosure in detail to the extent that a person skilled in the art to which the disclosure pertains can easily enforce the technical concept of the present disclosure.

It is to be understood herein that embodiments of the present disclosure are not limited to the particulars shown in the drawings and that the drawings are not necessarily to scale and in some instances proportions may have been exaggerated in order to more clearly depict certain features of the disclosure. While particular terminology is used herein, it is to be appreciated that the terminology used herein is for the purpose of describing particular embodiments only and is not intended to limit the scope of the present disclosure.

As used herein, the term “and/or” includes any and all combinations of one or more of the associated listed items. It will be understood that when an element is referred to as being “on,” “connected to” or “coupled to” another element, it may be directly on, connected or coupled to the other element or intervening elements may be present. As used herein, a singular form is intended to include plural forms as well, unless the context clearly indicates otherwise. It will be further understood that the terms “includes” and/or “Including,” when used in this specification, specify the presence of at least one stated feature, step, operation, and/or element, but do not preclude the presence or addition of one or more other features, steps, operations, and/or elements thereof.

Hereinafter, a data storage device and a data processing system including the same according to the present disclosure will be described below with reference to the accompanying drawings through exemplary embodiments.

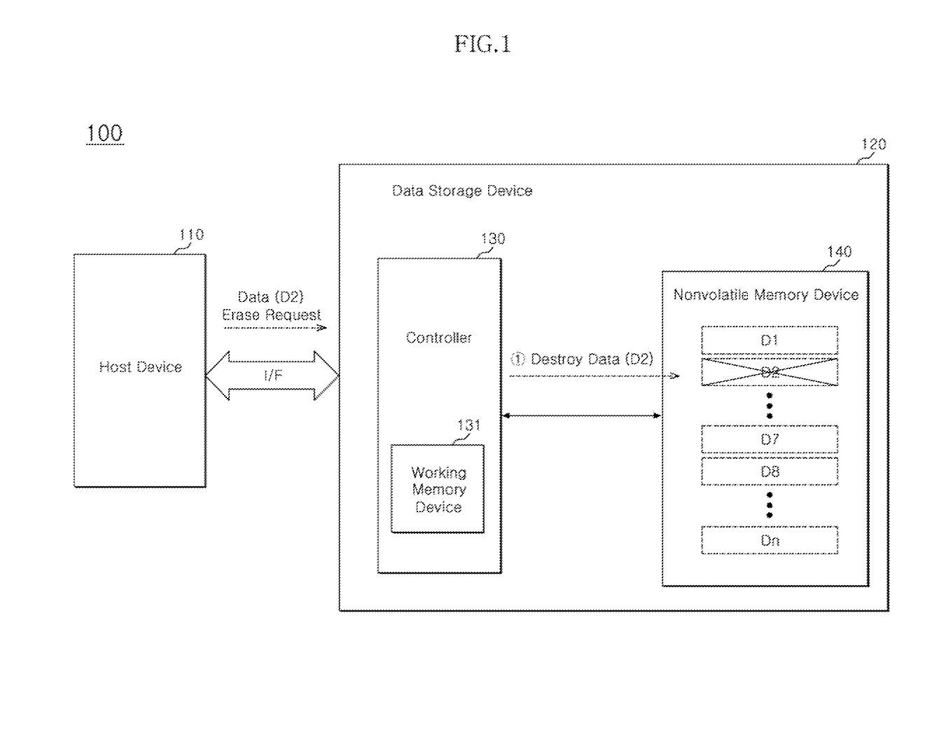

FIG. 1 is a block diagram explaining a data erase operation of a data processing system in accordance with an embodiment of the present disclosure. A data processing system 100 may include a host device 110 and a data storage device 120.

The host device 110 may include any one of a portable electronic device such as a mobile phone, an MP3 player, a digital camera, a laptop computer, and an electronic device such as a desktop computer, a game player, a TV, and an in-vehicle entertainment system.

The data storage device 120 may store data to be accessed by the host device 110. The data storage device 120 may also be referred to as a memory system.

The data storage device 120 may be manufactured as one of various kinds of storage devices depending on the protocol of an interface (I/F) though which it communicates with the host device 110. For example, the data storage device 120 may be configured as any one of various kinds of storage devices such as a solid state drive, a multimedia card in the form of an MMC, an eMMC, a RS-MMC and a micro-MMC, a secure digital card in the form of an SD, a mini-SD and a micro-SD, a universal serial bus (USB) storage device, a universal flash storage (UFS) device, a personal computer memory card international association (PCMCIA) memory card, a peripheral component interconnection (PCI) memory card, a PCI express (PCI-E) memory card, a compact flash (CF) card, a smart media card, a memory stick, and so forth.

The data storage device 120 may include a controller 130 and a nonvolatile memory device 140.

The controller 130 may control the nonvolatile memory device 140 in response to a request from the host device 110. For example, the controller 130 may provide the data read from the nonvolatile memory device 140 to the host device 110. Also, the controller 130 may store the data provided from the host device 110 in the nonvolatile memory device 140. For these operations, the controller 130 may control the read, write (or program), and erase operations of the nonvolatile memory device 140.

The controller 130 may control the general operations of the data storage device 120 through driving of firmware or software, which is loaded on a working memory device 131. The controller 130 may decode and drive a code type instruction or algorithm such as firmware or software. The controller 130 may be realized as hardware or a combined type of hardware and software. The controller 130 may include a micro control unit (MCU) and a central processing unit (CPU).

The working memory device 131 may store firmware or software to be driven by the controller 130, and data used to drive the firmware or the software. The working memory device 131 may temporarily store data to be transmitted from the host device 110 to the nonvolatile memory device 140 or from the nonvolatile memory device 140 to the host device 110. Namely, the working memory device 131 may operate as a buffer memory device or a cache memory device.

The nonvolatile memory device 140 may operate as the storage medium of the data storage device 120. The nonvolatile memory device 140 may include any one of various types of nonvolatile memory devices such as a NAND type flash memory device, a NOR type flash memory device, a ferroelectric random access memory (FRAM) using ferroelectric capacitors, a magnetic random access memory (MRAM) using a tunneling magneto-resistive (TMR) layer, a phase change random access memory (PRAM) using a chalcogenide, and a resistive random access memory (ReRAM) using a transition metal oxide. The nonvolatile memory device 140 may include a combination of a NAND type flash memory device and one or more of the various types of nonvolatile memory devices described above.

The host device 110 may request erasure of the data stored in the data storage device 120 in a variety of ways. For instance, the host device 110 may request immediate erasure of data. In this case, the data storage device 120 may immediately erase erase-requested data and may inform the host device 110 that erasure is completed. For another instance, the host device 110 may request general erasure of data. In this case, the data storage device 120 may erase data according to a job schedule and may inform the host device 110 that erasure is completed. In detail, when there is no job that is being currently performed, the data storage device 120 may immediately erase erase-requested data and may inform the host device 110 that erasure is completed. When there is a job that is being currently performed, the data storage device 120 may first inform the host device 110 that erasure is completed, before erasing data, and may then erase erase-requested data after the job that is being currently performed is completed.

The host device 110 may store various kinds of data, which are used by a user, in the data storage device 120. For example, the host device 110 may store data, such as document data and media data, which are not sensitive to security, in the data storage device 120. For another example, the host device 110 may store data, such as data associated with personal or financial information of a user and data limited for a specified user to use, which are sensitive to security (hereinafter, referred to as security data), in the data storage device 120.

For simple explanation, it is described as an example that data D2 stored in the data storage device 120 is security data. The host device 110 may request immediate erasure of the security data D2 to prevent exposure of the security data D2. In this case, the data storage device 120 is to immediately erase the erase-requested data D2. If the data storage device 120 requires a lengthy period in erasing the security data D2, the performance of not only the data storage device 120 but also the host device 110 may be degraded.

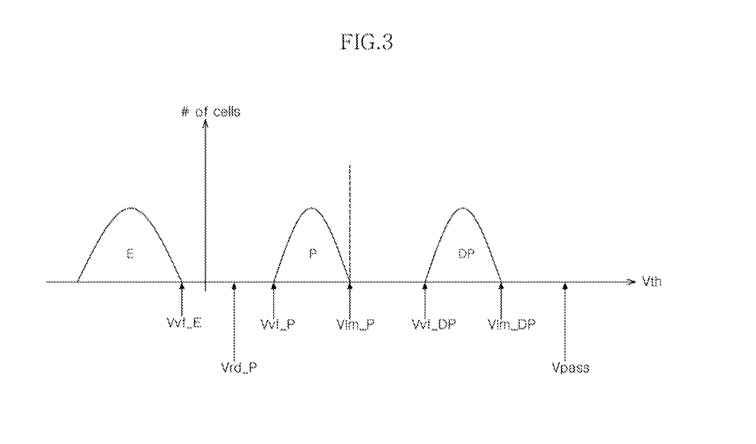

According to the embodiment of the present disclosure, when the host device 110 requests immediate erasure of the data D2, the erase-requested data D2 may be destroyed in such a manner that the data D2 may not be identified. For example, the controller 130 may destroy the data D2 not to be identified by changing the threshold voltage of a memory cell of the nonvolatile memory device 140 in which the erase-requested data D2 is stored. In order to destroy the erase-requested data D2, the controller 130 may control the nonvolatile memory device 140 in such a manner that the memory cell in which the erase-requested data D2 is stored is programmed. Methods of destroying the erase-requested data D2 will be described later in detail with reference to FIGS. 3 to 5.

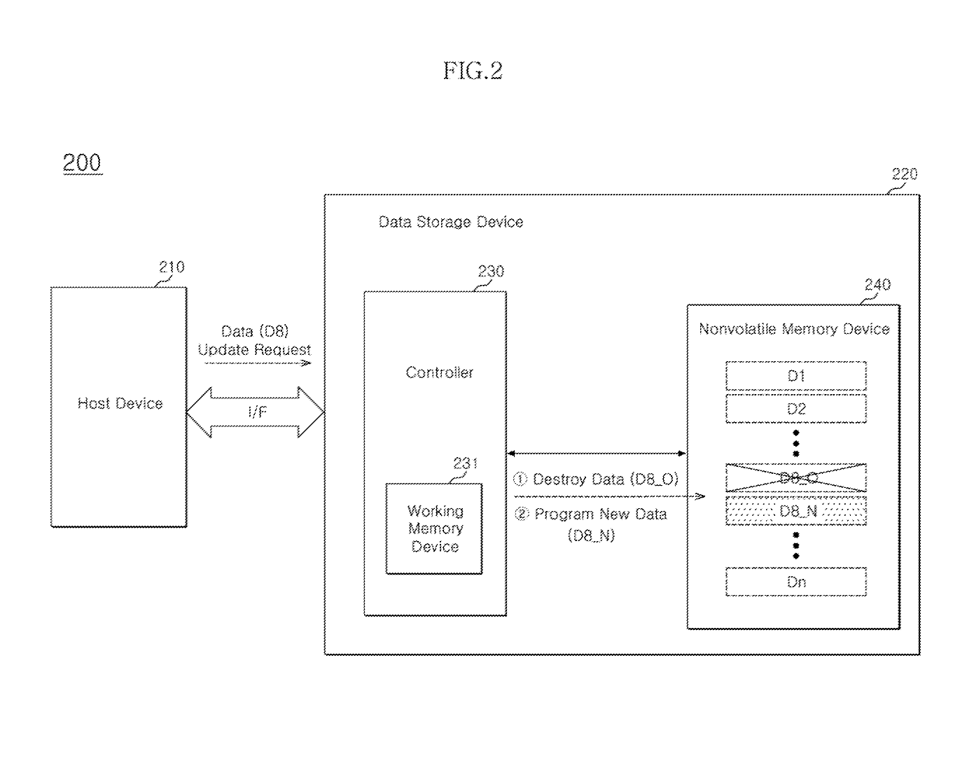

FIG. 2 is a block diagram explaining a data update operation of a data processing system in accordance with an embodiment of the present disclosure. A data processing system 200 may include a host device 210 and a data storage device 220. The data storage device 220 may include a controller 230 and a nonvolatile memory device 240. The controller 230 may include a working memory device 231. The configurations and operations of the host device 210 and the data storage device 220 may be the same as the configurations and operations of the host device 110 and the data storage device 120 of FIG. 1. Therefore, for simpler and clearer explanation, detailed descriptions for the host device 210 and the data storage device 220 will be omitted herein.

The host device 210 may request update of the data, which is stored in the data storage device 220. The data storage device 220 may respond to the update request of the host device 210 in a variety of ways. For instance, when the memory cell of the nonvolatile memory device 240 may be overwritten, the data storage device 220 may overwrite new data in the memory cell in which previous data is stored. For another instance, when the memory cell of the nonvolatile memory device 240 may not be overwritten, the data storage device 220 may erase the previous data requested to be updated and may program new data in another memory cell.

For simple and clear explanation, it is described as an example that data D8 stored in the data storage device 220 is security data such as data associated with personal or financial information of a user. The host device 210 may request update of the security data D8 as the occasion demands. When the memory cell of the nonvolatile memory device 240 may not be overwritten as described above, an erase operation may be performed in the data storage device 220 to update the security data D8. In order to prevent exposure of previous security data D8_O, the data storage device 220 is to immediately erase the previous security data D8_O. If it takes a lengthy period for the data storage device 220 to erase the previous security data D8_O, the performance of not only the data storage device 220 but also the host device 210 may be degraded.

According to the embodiment of the present disclosure, when it is necessary to erase the previous security data D8_O in response to the update request of the host device 210 for the security data D8, the data storage device 220 may destroy the previous security data D8_O in such a manner that the previous security data D8_O may not be identifiable instead of actually erasing the previous security data D8_O through an erase operation. For example, the controller 230 may destroy the previous security data D8_O in such a manner that the previous security data D8_O may not be identifiable, by changing the threshold voltage of a memory cell of the nonvolatile memory device 240 in which the previous security data D8_O is stored. In order to destroy the previous security data D8_O, the controller 230 may control the nonvolatile memory device 240 in such a manner that the memory cell in which the previous security data D8_O is stored is programmed. Methods of destroying the previous security data D8_O for updating will be described below in detail with reference to FIGS. 3 to 5.

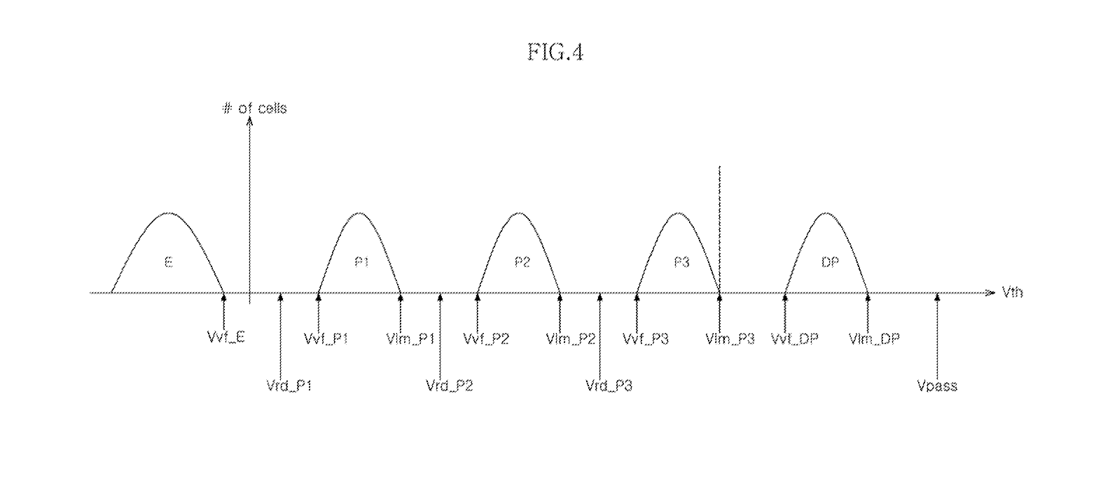

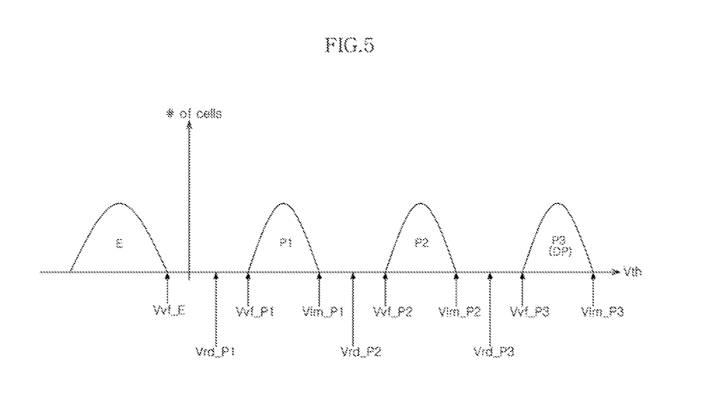

FIGS. 3 to 5 are threshold voltage distribution diagrams of memory cells of the nonvolatile memory devices of FIGS. 1 and 2. For example, single level memory cells are described in FIG. 3, while multi-level memory cells are described in FIGS. 4 and 5. With reference to FIGS. 3 to 5, the data destruction method of FIGS. 1 and 2 (that is, the destruction operation performed in the process \textcircled{1}) will be described in detail.

Although not shown, each of the nonvolatile memory devices 140 and 240 of FIGS. 1 and 2 may include a plurality of memory cells, which are disposed at crossing regions of bit lines and word lines.

According to an exemplary embodiment of FIG. 3, each memory cell may store 1-bit data. Such a memory cell is referred to as a single level memory cell. The single level memory cell capable of storing 1-bit data may be erased to an erased state E or may be programmed to a programmed state P. For instance, if the memory cell is erased, the memory cell may have a threshold voltage equal to or lower than an erase verify voltage Vvf_E. Also, if the memory cell is programmed, the memory cell may have a threshold voltage between a program verify voltage Vvf_P and a program limit voltage Vlm_P. The erase verify voltage Vvf_E means a voltage for verifying whether or not a memory cell on which an erase operation is performed is erased to a target erased state. The program verify voltage Vvf_P means a voltage for verifying whether or not a memory cell on which a program operation is performed is programmed to a target programmed state.

When a read operation is performed on a programmed memory cell, a read voltage Vrd_P may be provided to the word line of a selected memory cell. The read voltage Vrd_P may have a voltage value between the erase verify voltage Vvf_E and the program verify voltage Vvf_P. For instance, when the read voltage Vrd_P is applied, a memory cell, which has the threshold voltage of the erased state E, may be sensed as an on cell, and a memory cell, which has the threshold voltage of the programmed state P, may be sensed as an off cell.

In accordance with the embodiment of the present disclosure, existing data of a memory cell, which is to be erased (hereinafter, referred to as erase target data), may be destroyed by changing the threshold voltage of the memory cell. For instance, a memory cell in which erase target data is stored may be programmed to a state other than the normal erased state E and the normal programmed state P. That is to say, if erase target data is destroyed, the memory cell in which the erase target data is stored may be in a destroyed program state DP. The destroyed program state DP may mean a programmed state, which is newly generated to destroy data by changing a programmed state instead of performing erasure of data. If a memory cell in which erase target data is stored is programmed to the new destroyed program state DP, since such a memory cell is recognized as being stored with new data, existing data, i.e., the erase target data, may not be identified.

The memory cell, which is programmed to the destroyed program state DP, may have a threshold voltage that is higher than the normal erased state E and the normal programmed state P. For instance, if a memory cell is programmed to the destroyed program state DP, such a memory cell may have a threshold voltage between a destroyed program verify voltage Vvf_DP and a destroyed program limit voltage Vlm_DP.

As shown in FIG. 3, the lowest threshold voltage of the memory cell, which is programmed to the destroyed program state DP (for example, the destroyed program verify voltage Vvf_DP), may have a voltage value that is higher than the highest threshold voltage of the normal programmed state P (for example, the program limit voltage Vlm_P). Also, the highest threshold voltage of the memory cell, which is programmed to the destroyed program state DP (for example, the destroyed program limit voltage Vlm_DP), may have a voltage value that is lower than an unselected read voltage Vpass. The unselected read voltage Vpass means a voltage, which is applied to the word line of an unselected memory cell when a read operation is performed on a selected memory cell. If the unselected read voltage Vpass is applied to the word line of the unselected memory cell, the unselected memory cell is turned on and does not exert any influence on the cell current of the selected memory cell.

According to exemplary embodiments of FIGS. 4 and 5, each of the memory cells may store 2 or more-bit data. Such a memory cell is referred to as a multi-level memory cell. For simple and clear explanation of FIGS. 4 and 5, each memory cell will be exemplified as a multi-level cell (MLC) capable of storing 2 bit data.

A multi-level cell capable of storing 2 bit data may be erased to an erased state E or may be programmed to any one of a plurality of programmed states P1, P2, and P3. For instance, if a memory cell is erased, such a memory cell may have a threshold voltage equal to or lower than an erase verify voltage Vvf_E. Also, if a memory cell is programmed, such a memory cell may have a threshold voltage between a first program verify voltage Vvf_P1 and a first program limit voltage Vlm_P1, between a second program verify voltage Vvf_P2 and a second program limit voltage Vlm_P2, or between a third program verify voltage Vvf_P3 and a third program limit voltage Vlm_P3. The erase verify voltage Vvf_E means a voltage for verifying whether or not a memory cell on which an erase operation is performed is erased to a target erased state. The respective program verify voltages Vvf_P1, Vvf_P2, and Vvf_P3 mean voltages for verifying whether or not a memory cell on which a program operation is performed is programmed to target programmed states P1, P2, and P3.

When a read operation is performed on a programmed memory cell, any one of read voltages Vrd_P1, Vrd_P2, and Vrd_P3 may be provided to the word line of a selected memory cell. The first read voltage Vrd_P1 may have a voltage between the erase verify voltage Vvf_E and the first program verify voltage Vvf_P1. The second read voltage Vrd_P2 may have a voltage between the first program limit voltage Vlm_P1 and the second program verify voltage Vvf_P2. The third read voltage Vrd_P3 may have a voltage between the second program limit voltage Vlm_P2 and the third program verify voltage Vvf_P3.

For instance, when the first read voltage Vrd_P1 is applied, a memory cell, which has the threshold voltage of the erased state E, may be sensed as an on cell, and a memory cell, which has the threshold voltage of any one of the first to third programmed states P1, P2, and P3, may be sensed as an off cell. When the second read voltage Vrd_P2 is applied, a memory cell, which has the threshold voltage of any one of the erased state E and the first programmed state P1, may be sensed as an on cell, and a memory cell, which has the threshold voltage of any one of the second and third programmed states P2 and P3, may be sensed as an off cell. When the third read voltage Vrd_P3 is applied, a memory cell, which has the threshold voltage of any one of the erased state E and the first and second programmed states P1 and P2, may be sensed as an on cell, and a memory cell, which has the threshold voltage of the third programmed state P3, may be sensed as an off cell.

In accordance with the embodiment of the present disclosure, existing data of a memory cell, which is to be erased (hereinafter, referred to as erase target data), may be destroyed by changing the threshold voltage of the memory cell. For instance, a memory cell in which erase target data is stored may be programmed to a state other than the normal erased state E and the normal programmed states P1, P2, and P3. That is to say, if erase target data is destroyed, the memory cell in which the erase target data is stored may be in a destroyed program state DP. If a memory cell in which erase target data is stored is programmed to the new destroyed program state DP, since such a memory cell is recognized as being stored with new data, existing data, i.e., the erase target data, may not be identified.

Referring to FIG. 4, the destroyed program state DP may mean a programmed state, which is newly generated to destroy data by changing a programmed state instead of performing erasure of data. The memory cell, which is programmed to the destroyed program state DP, may have a threshold voltage that is higher than the normal erased state E and the normal programmed states P1, P2, and P3. For instance, if a memory cell is programmed to the destroyed program state DP, such a memory cell may have a threshold voltage between a destroyed program verify voltage Vvf_DP and a destroyed program limit voltage Vlm_DP.

As shown in FIG. 4, the lowest threshold voltage of the memory cell, which is programmed to the destroyed program state DP (for example, the destroyed program verify voltage Vvf_DP), may have a voltage value that is higher than the highest threshold voltage of the programmed state P3 having a highest threshold voltage distribution among the normal programmed states P1, P2, and P3 (for example, the third program limit voltage Vlm_P3). Also, the highest threshold voltage of the memory cell, which is programmed to the destroyed program state DP (for example, the destroyed program limit voltage Vlm_DP), may have a voltage value that is lower than an unselected read voltage Vpass. The unselected read voltage Vpass means a voltage, which is applied to the word line of an unselected memory cell when a read operation is performed on a selected memory cell. If the unselected read voltage Vpass is applied to the word line of the unselected memory cell, the unselected memory cell is turned on and does not exert any influence on the cell current of the selected memory cell.

Referring to FIG. 5, a destroyed program state DP may mean a programmed state P3 that has a highest threshold voltage distribution among programmed states to destroy data by changing a programmed state instead of performing erasure of data. If a memory cell in which erase target data is stored is programmed to the programmed state P3, since such a memory cell is recognized as being stored with new data, existing data may not be identified.

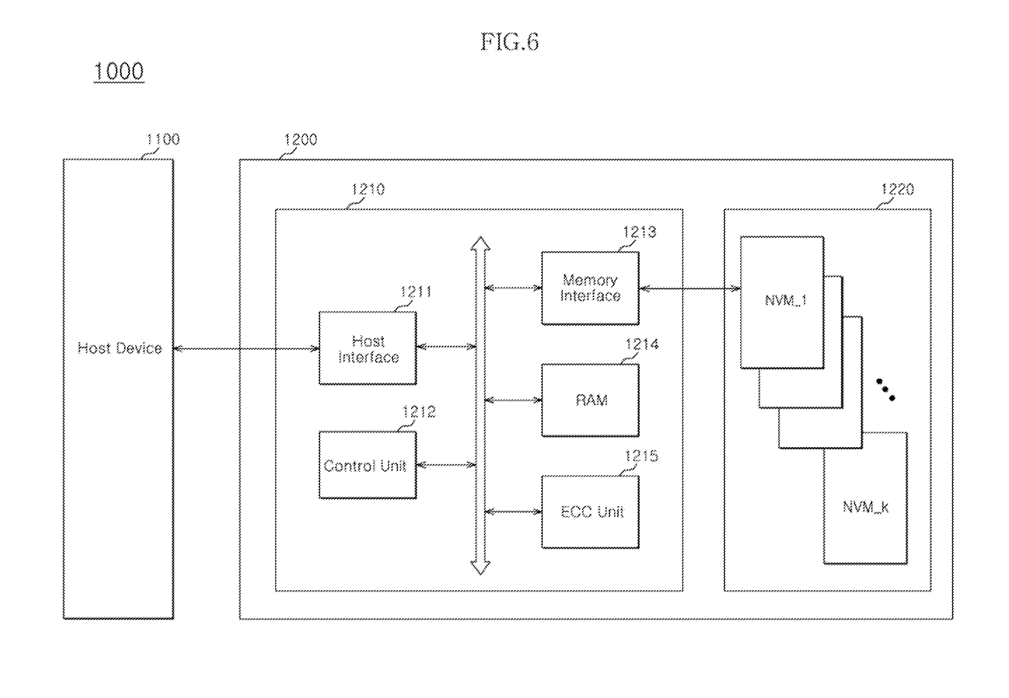

FIG. 6 is a block diagram exemplarily showing a data processing system in accordance with an embodiment of the present disclosure. Referring to FIG. 6, a data processing system 1000 may include a host device 1100 and a data storage device 1200.

The data storage device 1200 may include a controller 1210 and a nonvolatile memory device 1220. The data storage device 1200 may be used by being electrically coupled to the host device 1100 such as a desktop computer, a laptop computer, a digital camera, a mobile phone, an MP3 player, a game player, and so forth. The data storage device 1200 is also referred to as a memory system.

The controller 1210 may access the nonvolatile memory device 1220 in response to a request from the host device 1100. For example, the controller 1210 may control the read, program, or erase operation of the nonvolatile memory device 1220. The controller 1210 may drive firmware or software for controlling the nonvolatile memory device 1220.

The controller 1210 may perform a data destruction operation in accordance with the embodiment of the present disclosure. That is to say, when the controller 1210 receives an erase request (for example, an immediate erase request) from the host device 1100, the controller 1210 may change the threshold voltage of a memory cell, in which erase-requested data is stored, through a program operation, instead of erasing the erase-requested data through an erase operation. If the threshold voltage of the memory cell in which the erase-requested data is stored is changed, the erase-requested data may be changed to an unidentifiable state.

The controller 1210 may include a host interface 1211, a control unit 1212, a memory Interface 1213, a RAM 1214, and an error correction code (ECC) unit 1215.

The control unit 1212 may control the general operations of the controller 1210 in response to a request from the host device 1100. The RAM 1214 may be used as the working memory of the control unit 1212. The RAM 1214 may temporarily store the data read from the nonvolatile memory device 1220 or the data provided from the host device 1100.

The host interface 1211 may interface the host device 1100 and the controller 1210. For example, the host interface 1211 may communicate with the host device 1100 through one of various interface protocols such as a universal serial bus (USB) protocol, a universal flash storage (UFS) protocol, a multimedia card (MMC) protocol, a peripheral component interconnection (PCI) protocol, a PCI express (PCI-E) protocol, a parallel advanced technology attachment (PATA) protocol, a serial advanced technology attachment (SATA) protocol, a small computer system interface (SCSI) protocol, and a serial attached SCSI (SAS) protocol.

The memory interface 1213 may interface the controller 1210 and the nonvolatile memory device 1220. The memory interface 1213 may provide a command and an address to the nonvolatile memory device 1220. Furthermore, the memory interface 1213 may exchange data with the nonvolatile memory device 1220.

The error correction code unit 1215 may detect an error of the data read from the nonvolatile memory device 1220. Also, the error correction code unit 1215 may correct the detected error when the detected error falls within a correctable range. Meanwhile, the error correction code unit 1215 may be provided inside or outside the controller 1210 depending on the features of the data processing system 1000.

The nonvolatile memory device 1220 may be used as the storage medium of the data storage device 1200. The nonvolatile memory device 1220 may include a plurality of nonvolatile memory chips (or dies) NVM_{—}1 to NVM_k.

The controller 1210 and the nonvolatile memory device 1220 may be manufactured as any one of various data storage devices. For example, the controller 1210 and the nonvolatile memory device 1220 may be integrated into one semiconductor apparatus and may be manufactured as any type of a multimedia card in the form of an MMC, an eMMC, an RS-MMC and a micro-MMC, a secure digital card in the form of an SD, a mini-SD and an micro-SD, a universal serial bus (USB) storage device, a universal flash storage (UFS) device, a personal computer memory card international association (PCMCIA) memory card, a compact flash (CF) card, a smart media card, and a memory stick.

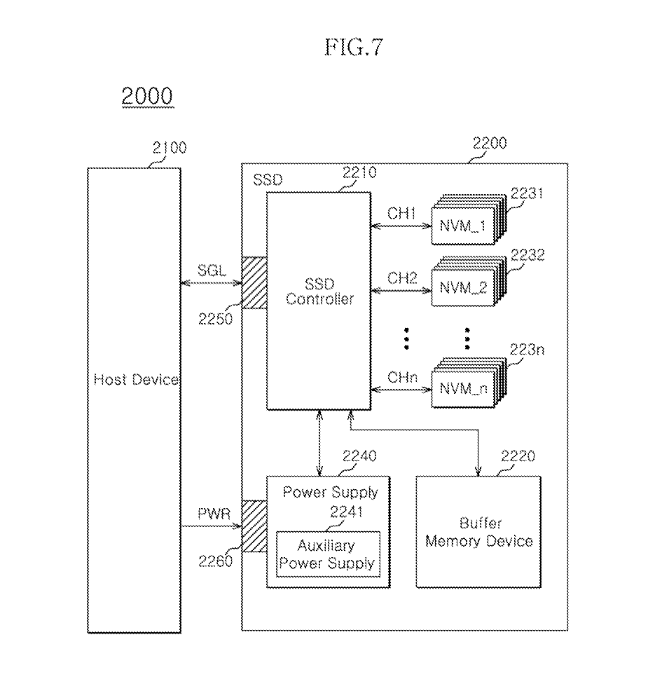

FIG. 7 is a block diagram exemplarily showing a data processing system, which includes a solid state drive (SSD), in accordance with an embodiment of the present disclosure. Referring to FIG. 7, a data processing system 2000 may include a host device 2100 and an SSD 2200.

The SSD 2200 may include an SSD controller 2210, a buffer memory device 2220, nonvolatile memory devices 2231 to 223n, a power supply 2240, a signal connector 2250, and a power connector 2260.

The SSD 2200 may operate in response to a request from the host device 2100. That is to say, the SSD controller 2210 may access the nonvolatile memory devices 2231 to 223n in response to a request from the host device 2100. For example, the SSD controller 2210 may control the read, program, and erase operations of the nonvolatile memory devices 2231 to 223n.

The SSD controller 2210 may perform a data destruction operation in accordance with the embodiment of the present disclosure. That is to say, when the SSD controller 2210 receives an erase request (for example, an immediate erase request) from the host device 2100, the SSD controller 2210 may change the threshold voltage of a memory cell in which erase-requested data is stored through a program operation, instead of erasing the erase-requested data through an erase operation. If the threshold voltage of the memory cell in which the erase-requested data is stored is changed, the erase-requested data may be changed to an unidentifiable state.

The buffer memory device 2220 may temporarily store data, which are to be stored in the nonvolatile memory devices 2231 to 223n. Further, the buffer memory device 2220 may temporarily store data, which are read from the nonvolatile memory devices 2231 to 223n. The data temporarily stored in the buffer memory device 2220 may be transmitted to the host device 2100 or the nonvolatile memory devices 2231 to 223n under the control of the SSD controller 2210.

The nonvolatile memory devices 2231 to 223n may be used as storage media of the SSD 2200. The nonvolatile memory devices 2231 to 223n may be electrically coupled to the SSD controller 2210 through a plurality of channels CH1 to CHn, respectively. One or more nonvolatile memory devices may be electrically coupled to one channel. The nonvolatile memory devices electrically coupled to one channel may be electrically coupled to the same signal bus and data bus.

The power supply 2240 may provide power PWR inputted through the power connector 2260 to the inside of the SSD 2200. The power supply 2240 may include an auxiliary power supply 2241. The auxiliary power supply 2241 may supply power so as to allow the SSD 2200 to be properly terminated when a sudden power-off occurs. The auxiliary power supply 2241 may include super capacitors capable of being charged with power PWR.

The SSD controller 2210 may exchange a signal SGL with the host device 2100 through the signal connector 2250. The signal SGL may include a command, an address, data, and so forth. The signal connector 2250 may be, for example, connectors of parallel advanced technology attachment (PATA), serial advanced technology attachment (SATA), small computer system interface (SCSI), serial attached SCSI (SAS), peripheral component interconnection (PCI), and PCI express (PCI-E), depending on an interface scheme between the host device 2100 and the SSD 2200.

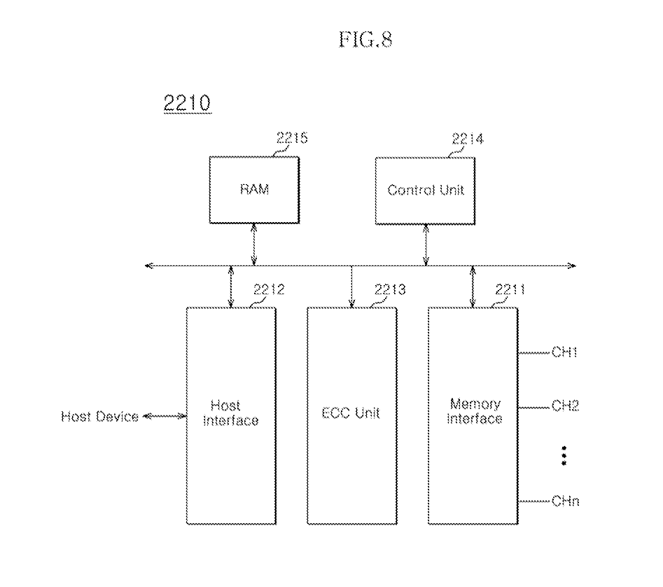

FIG. 8 is a block diagram exemplarily showing the SSD controller shown in FIG. 7. Referring to FIG. 8, the SSD controller 2210 includes a memory interface 2211, a host interface 2212, an error correction code (ECC) unit 2213, a control unit 2214, and a RAM 2215.

The memory interface 2211 may provide a command and an address to the nonvolatile memory devices 2231 to 223n. Moreover, the memory interface 2211 may exchange data with the nonvolatile memory devices 2231 to 223n. The memory interface 2211 may distribute the data transmitted from the buffer memory device 2220 to the respective channels CH1 to CHn, under the control of the control unit 2214. Furthermore, the memory interface 2211 may transfer the data read from the nonvolatile memory devices 2231 to 223n to the buffer memory device 2220, under the control of the control unit 2214.

The host interface 2212 may provide an interface with the SSD 2200 in correspondence to the protocol of the host device 2100. For example, the host interface 2212 may communicate with the host device 2100 through one of parallel advanced technology attachment (PATA), serial advanced technology attachment (SATA), small computer system interface (SCSI), serial attached SCSI (SAS), peripheral component interconnection (PCI), and PCI express (PCI-E) protocols. In addition, the host interface 2212 may perform a disk emulating function of supporting the host device 2100 to recognize the SSD 2200 as a hard disk drive (HDD).

The ECC unit 2213 may generate parity bits based on the data transmitted to the nonvolatile memory devices 2231 to 223n. The generated parity bits may be stored in spare areas of the nonvolatile memory devices 2231 to 223n. The ECC unit 2213 may detect an error of the data read from the nonvolatile memory devices 2231 to 223n. When the detected error falls within a correctable range, the ECC unit 2213 may correct the detected error.

The control unit 2214 may analyze and process a signal SGL inputted from the host device 2100. The control unit 2214 may control the general operations of the SSD controller 2210 in response to a request from the host device 2100. The control unit 2214 may control the operations of the buffer memory device 2220 and the nonvolatile memory devices 2231 to 223n based on firmware for driving the SSD 2200. The RAM 2215 may be used as a working memory device for driving the firmware.

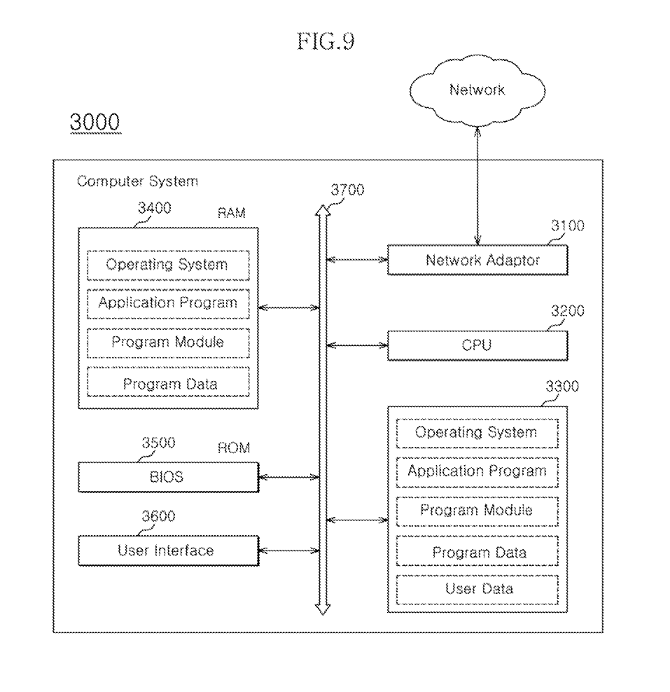

FIG. 9 is a block diagram exemplarily showing a computer system in which the data storage device in accordance with the embodiment of the present disclosure is mounted. Referring to FIG. 9, a computer system 3000 includes a network adaptor 3100, a central processing unit 3200, a data storage device 3300, a RAM 3400, a ROM 3500, and a user interface 3600, which are electrically coupled to a system bus 3700. The data storage device 3300 may include the data storage device 120 shown in FIG. 1, the data storage device 220 shown in FIG. 2, the data storage device 1200 shown in FIG. 6 or the SSD 2200 shown in FIG. 7.

The network adaptor 3100 provides the interface between the computer system 3000 and external networks. The central processing unit 3200 performs general operations for driving an operating system or an application program in the RAM 3400.

The data storage device 3300 stores general data necessary in the computer system 3000. For example, an operating system for driving the computer system 3000, an application program, various program modules, program data, and user data are stored in the data storage device 3300.

The RAM 3400 may be used as a working memory device of the computer system 3000. Upon booting, the operating system, the application program, the various program modules, and the program data necessary for driving programs, which are read from the data storage device 3300, are loaded on the RAM 3400. A BIOS (basic input/output system), which is activated before the operating system is driven, is stored in the ROM 3500. Information exchange between the computer system 3000 and a user is implemented through the user interface 3600.

Although not shown in a drawing, it is to be readily understood that the computer system 3000 may further include devices such as an application chipset, a camera image processor (CIS), and so forth.

While certain embodiments have been described above, it will be understood to those skilled in the art that the embodiments described are by way of example only. Accordingly, the data storage device and the data processing system including the same described herein should not be limited based on the described embodiments. Rather, the data storage device and the data processing system including the same described herein should only be limited in light of the claims that follow.

What is claimed is:

1. A data processing system comprising:
a data storage device including memory cells, which are erased to an erasure state and programmed to program states to store data; and
a host device suitable for accessing the data,
wherein the data storage device programs a first memory cell to a first program state other than the erasure state to delete data of the first memory cell in response to a request of the host device.

2. The data processing system according to claim 1, wherein the first memory cell is programmed to the first program state other than the program states to delete the data thereof.

3. The data processing system according to claim 2, wherein the data storage device is suitable for programming the first memory cell to have a threshold voltage that is higher than a threshold voltage of a second memory cell, which is programmed to one of the program states.

4. The data processing system according to claim 2, wherein the data storage device is suitable for programming the first memory cell to have a threshold voltage that is lower than an unselected read voltage for turning on an unselected memory cell when a read operation is performed for a memory cell selected among the memory cells.

5. The data processing system according to claim 1, wherein the first program state includes a program state having a highest threshold voltage distribution among the program states.

6. The data processing system according to claim 1, wherein the request of the host device includes a request for deleting security data.

7. The data processing system according to claim 6, wherein the data storage device comprises:
a nonvolatile memory device including the memory cells and suitable for storing the data; and
a controller suitable for controlling the nonvolatile memory device in response to the request of the host device.

8. The data processing system according to claim 7, wherein the controller is suitable for controlling the nonvolatile memory device to immediately program the first memory cell in which the security data is stored.

9. A data storage device comprising:
a nonvolatile memory device including memory cells, which are erased to an erasure state and programmed to program states to store data; and
a controller suitable for deleting data of a first memory cell by changing a threshold voltage of the first memory cell to a first program state other than the erasure state.

10. The data storage device according to claim 9, wherein the controller is suitable for controlling a program operation of the nonvolatile memory device to change the threshold voltage of the first memory cell and deleting the data of the first memory cell.

11. The data storage device according to claim 10, wherein the threshold voltage of the first memory cell is changed to be higher than a threshold voltage of a second memory cell, which is programmed to one of the program states.

12. The data storage device according to claim 10, wherein the threshold voltage of the first memory cell is changed to be lower than an unselected read voltage for turning on an unselected memory cell when a read operation is performed for a memory cell selected among the memory cells.

13. The data storage device according to claim 10, wherein the first program state includes a program sate having a highest threshold voltage distribution among the program states.

14. The data storage device according to claim 9, wherein the data of the first memory cell comprises data associated with personal information, data associated with financial information, or data with a limited use.

15. A data processing system comprising:
a host device;
a data storage device suitable for storing data which are to be accessed by the host device and comprising a nonvolatile memory device which includes memory cells; and
a controller suitable for controlling the nonvolatile memory device,
wherein, when erasure of data is requested from the host device, the controller controls the nonvolatile memory device such that a target memory cell in which erase-requested data is stored is programmed.

16. The data processing system according to claim 15, wherein the target memory cell is programmed to a destroyed program state other than a normal programmed state.

17. The data processing system according to claim 16, wherein a threshold voltage of the target memory cell which is programmed to the destroyed program state is higher than a threshold voltage of a memory cell which is programmed to the normal programmed state.

18. The data processing system according to claim 16, wherein the threshold voltage of the target memory cell which is programmed to the destroyed program state is lower than an unselected read voltage for turning on an unselected memory cell when a read operation is performed for a memory cell selected among the memory cells.

19. The data processing system according to claim 15, wherein the target memory cell is programmed to a programmed state having a highest threshold voltage among normal programmed states.
